(19) United States
(12) Patent Application Publication
(10) Pub. No.: US 2025/0386271 A1
(43) Pub. Date: Dec. 18, 2025

(54) METHOD AND SYSTEM FOR HANDLING SLICE-BASED CELL RESELECTION PRIORITIES

(71) Applicant: Samsung Electronics Co., Ltd., Gyeonggi-do (KR)

(72) Inventor: Aby KANNEATH ABRAHAM, Bangalore (IN)

(21) Appl. No.: 18/876,012

(22) PCT Filed: Jun. 16, 2023
(86) PCT No.: PCT/KR2023/008391

§ 371 Date: Dec. 17, 2024

(30) Foreign Application Priority Data
Jun. 17, 2022 (IN) 202241034929
Feb. 25, 2023 (IN) 202341012940
May 16, 2023 (IN) 202241034929

(51) Int. Cl. H04W 36/00; H04W 36/24

(52) U.S. Cl. CPC H04W 36/13; H04W 36/0072; H04W 36/24

(57) ABSTRACT

The disclosure relates to a 5G or 6G communication system for supporting a higher data transmission rate. Embodiments of the disclosure describe a method performed by a user equipment (UE) for determining one or more slice-based cell reselection priorities is provided, comprising the step of receiving a radio resource control (RRC) release message including at least one first configuration of slice-specific cell reselection information through a dedicated signaling, receiving, from a base station system information including at least one second configurations of slice-specific cell reselection information through a broadcast signaling, determining a network slice as groups (NSAG) and a frequency are indicated by the first configuration of the dedicated signaling but not indicated by the second configuration of the broadcast signaling, and considering, based on the determination that the NSAG and the frequency are indicated by the first configuration of the dedicated signaling but not indicated by the second configuration of the broadcast signaling that a cell of the frequency supports the NSAG or the NSAG and the frequency are not used for cell reselection priority in the cell.

### TECHNICAL FIELD

The present invention generally relates to a field of wireless communication, and more specifically relates to a method and a system for handling slice-based cell reselection priorities.

### BACKGROUND ART

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

A network slicing is the most prominent feature of 5G networks, which lies in adopting network slicing for radio access networks (RANs) and core networks (CNs). The network slicing is intended for bundling up network resources and network functions into a single independent network slice depending on individual services, allowing for an application of network system function and resource isolation, customization, independent management, and orchestration to mobile communication network architectures. The use of such network slicing enables offering 5G services in an independent and flexible way by selecting and combining 5G system network functions according to services, users, business models, etc.

According to 3GPP technical specification (TS) 38.300 release 16, a network slice always consists of a RAN part and a CN part. Further, support for the network slicing relies on a principle that traffic for different slices is handled by different protocol data unit (PDU) sessions. The network (e.g., 5G network) may realize the different network slices by scheduling and also by providing different L1 and/or L2 configurations. Further, the network slicing is a concept to allow differentiated treatment depending on each customer's requirements. With the network slicing, mobile network operator (MNO) can consider customers as belonging to different tenant types with each customer having different service requirements that govern in terms of what slice types of each tenant is eligible to use based on a service level agreement (SLA) and subscriptions.

Furthermore, some slices may be available only in part of the network. Next-generation radio access network (NG-RAN) supported single network slice selection assistance information (S-NSSAI) is configured by an operations administration and maintenance (OAM). Awareness in the NG-RAN of the slices supported in network cells and neighbors of the network cells may be beneficial for an inter-frequency mobility in a connected mode. There is an assumption that the slice availability does not change within a registration area of a user equipment (UE). The NG-RAN and 5GC are responsible to handle a service request for the slice that may or may not be available in a given area (e.g., registration area). Admission or rejection of access to the slice may depend on factors such as support for the slice, availability of resources, and support of the requested service by the NG-RAN. In case the UE is associated with multiple slices simultaneously, only one signalling connection is maintained and for an intra-frequency network cell reselection, the UE always tries to camp on an optimal network cell.

Until the new radio (NR) release 16, the NR networks were used when some of the slices were only supported in certain frequencies, and dedicated priorities were used to control the frequency on which the UE camps. Slice-specific prioritization is implemented in NR release 17. As a result, a serving network cell can broadcast slice information such as slice support in serving and neighboring frequencies, slice-specific priorities for serving and neighboring frequencies, details on slice availability in neighboring network cells, and so on. Further, there might be certain frequencies that aren't related to any slices. During cell reselection, the UE considers the slice priorities of the slices that the UE needs/supports, as well as the frequency priorities for the slices.

### DISCLOSURE OF INVENTION

### Technical Problem

The present disclosure relates to wireless communication systems and, more specifically, the present disclosure relates to a method and system for handling slice-based cell reselection priorities.

### Solution to Problem

In one embodiment, a method by a user equipment (UE) for determining one or more slice-based cell reselection priorities in a wireless network is provided, comprising the step of receiving a radio resource control (RRC) release message including at least one first configuration of slice-specific cell reselection information through a dedicated signaling, receiving, from a base station, system information including at least one second configurations of slice-specific cell reselection information through a broadcast signaling, determining a network slice as groups (NSAG) and a frequency are indicated by the first configuration of the dedicated signaling but not indicated by the second configuration of the broadcast signaling, and considering, based on the determination that the NSAG and the frequency are indicated by the first configuration of the dedicated signaling but not indicated by the second configuration of the broadcast signaling that a cell of the frequency supports the NSAG or the NSAG and the frequency are not used for cell reselection priority in the cell.

In another embodiment, a UE is provided, the UE comprises a transceiver and processor. The processor is configured to receive a radio resource control (RRC) release message including at least one first configuration of slice-specific cell reselection information through a dedicated signaling, receive, from a base station, system information including at least one second configuration of slice-specific cell reselection information through a broadcast signaling, determine a network slice as groups (NSAG) and a frequency are indicated by the first configuration of the dedicated signaling but not indicated by the second configuration of the broadcast signaling, and consider based on the determination that the NSAG and the frequency are indicated by the first configuration of the dedicated signaling but not indicated by the second configuration of the broadcast signaling, that a cell of the frequency supports the NSAG or the NSAG and the frequency are not used for cell reselection priority in the cell.

According to one embodiment of the present disclosure, a method for determining one or more slice-based cell reselection priorities in a wireless network is disclosed. The method includes receiving one or more configurations of slice-specific cell reselection information in a Radio Resource Control (RRC) release message from a network device through a dedicated signalling. The method further includes receiving one or more configurations of slice-specific cell reselection information in a broadcast signalling comprising a System Information Block (SIB) from the network device. The method further includes determining that one or more Network Slice As Groups (NSAG) frequency pairs of the one or more received configurations associated with the dedicated signalling are unavailable in the one or more received configurations associated with the broadcast signalling. The method further includes determining, based on the determination that the one or more NSAG frequency pairs of the one or more received configurations associated with the dedicated signalling are unavailable in the one or more received configurations associated with the broadcast signalling and the one or more received configurations of slice-specific cell reselection information in the RRC release message, one of, (a) the one or more slice-based cell reselection priorities from the one or more NSAG frequency pairs that are present in both the dedicated signalling and the broadcast signalling, without utilizing the one or more NSAG frequency pairs of the one or more received configurations associated with the dedicated signalling that is unavailable in the broadcast signalling; or (b) the one or more slice-based cell reselection priorities based on a consideration that all the cells in the frequency in the one or more NSAG frequency pairs of the one or more received configurations in the dedicated signalling support the NSAG in the one or more NSAG frequency pairs.

According to another embodiment of the present disclosure, a User Equipment (UE) for determining one or more slice-based cell reselection priorities in the wireless network is disclosed. The UE includes a system, the system includes a slice priority controller coupled with a processor and a memory. The slice priority controller receives the one or more configurations of slice-specific cell reselection information in the RRC release message from the network device through the dedicated signalling. The slice priority controller further receives the one or more configurations of slice-specific cell reselection information in the broadcast signalling comprising the SIB from the network device. The slice priority controller further determines that the one or more NSAG frequency pairs of the one or more received configurations associated with the dedicated signalling are unavailable in the one or more received configurations associated with the broadcast signalling. The slice priority controller further determines, based on the determination that the one or more NSAG frequency pairs of the one or more received configurations associated with the dedicated signalling are unavailable in the one or more received configurations associated with the broadcast signalling and the one or more received configurations of slice-specific cell reselection information in the RRC release message, one of, (a) the one or more slice-based cell reselection priorities from the one or more NSAG frequency pairs that are present in both the dedicated signalling and the broadcast signalling, without utilizing the one or more NSAG frequency pairs of the one or more received configurations associated with the dedicated signalling that is unavailable in the broadcast signalling; or (b) the one or more slice-based cell reselection priorities based on a consideration that all the cells in the frequency in the one or more NSAG frequency pairs of the one or more received configurations in the dedicated signalling support the NSAG in the one or more NSAG frequency pairs.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of a system for determining one or more slice-based cell reselection priorities in a wireless network, according to an embodiment as disclosed herein;

FIG. 2 illustrates a block diagram of a User Equipment (UE) for determining the one or more slice-based cell reselection priorities in the wireless network, according to an embodiment as disclosed herein;

FIG. 3 is a flow diagram illustrating a method for determining the one or more slice-based cell reselection priorities in the wireless network, according to an embodiment as disclosed herein;

FIG. 4 illustrates an operational flow diagram illustrating a method for performing a slice-specific cell reselection when slice-specific cell reselection information is received from a network device via a dedicated signalling but not via a broadcast signalling (e.g., system information (SIB-16)), according to an embodiment as disclosed herein;

FIG. 5 illustrates an operational flow diagram illustrating a method for performing the slice-specific cell reselection when slice-specific cell reselection information for an NSAG is received from the network device via the dedicated signalling but not via the broadcast signalling, according to an embodiment as disclosed herein;

FIG. 6 illustrates an operational flow diagram illustrating a method for performing a slice-specific cell reselection when slice-specific cell reselection information for a frequency for the NSAG is received from the network device via the dedicated signalling but not via the broadcast signalling, according to an embodiment as disclosed herein;

FIG. 7 illustrates an operational flow diagram illustrating a method for determining that the NSAG is supported by the frequency, according to an embodiment as disclosed herein;

FIG. 8 illustrates an operational flow diagram illustrating a method for determining that the NSAG is supported by a frequency, according to an embodiment as disclosed herein;

FIG. 9 illustrates an operational flow diagram illustrating a method for stopping a deprioritization along with slice-based reselection, according to an embodiment as disclosed herein; and

FIG. 10 illustrates an operational flow diagram illustrating a method for a dedicated slice-based priority deletion along with slice-based reselection, according to an embodiment as disclosed herein.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

According to 3GPP TS 38.300, cell reselection is a procedure that determines which cell the UE should camp on when the UE is in a non-connected state, i.e., radio resource control (RRC)_IDLE and RRC_INACTIVE, which is based on criteria for cell reselection. Further, inter-frequency reselection is based on absolute priorities where the UE tries to camp on the highest priority frequency available, which involves measurements of the serving network cells and neighbor network cells. The cell reselection may be speed dependent and in multi-beam operations, a cell quality is derived amongst the beams corresponding to the same network cell.

According to 3GPP TS 38.304 v16.5.0, the absolute priorities of different NR frequencies or inter-radio access technology (RAT) frequencies may be provided to the UE in system information, in the RRC release message, or by inheriting from another RAT at inter-RAT cell (re) selection. In the system information, an NR frequency or inter-RAT frequency may be listed without providing a priority (i.e., a field cellReselectionPriority is absent for that frequency). If priorities are provided in a dedicated signaling, the UE may ignore all the priorities provided in the system information. If the UE is in camped on any cell state, the UE may only apply the priorities provided by the system information from a current network cell, and the UE preserves priorities provided by the dedicated signalling and a de-prioritization request (deprioritisationReq) received in the RRC release message unless specified otherwise. When the UE is configured to perform an NR side link communication or a vehicle-to-everything (V2X) side link communication, for the cell reselection, the UE may consider the frequencies providing an intra-carrier and inter-carrier configuration to have equal priority in the cell reselection. As a result, the absolute priorities are mostly used during cell reselection, as mentioned below.

If a neighbor frequency has lower or equal priority than a serving frequency, the UE measures the frequencies for the cell reselection only when the serving network cell goes below a certain threshold decided by the network.

If the neighbor frequency has a higher priority than the serving frequency, then the UE measures the frequencies irrespective of the serving frequency thresholds.

Additionally, the UE may determine relax measurements based on a mobility of the UE or based on a distance of the UE from the serving network cell. The network may provide thresholds and conditions for the UE to the relax measurements. The conditions can be different for the low priority frequencies and the high priority frequencies.

Additionally, the UE may perform a cell reselection evaluation process based on different thresholds and different conditions depending on whether the neighbor frequency is having lower/equal/higher priority than the serving frequency. If multiple neighbor cells satisfy a cell reselection evaluation criteria, the UE reselects to a neighboring network cell belonging to a higher priority frequency. The UE may perform the cell reselection evaluation process on the following triggers when the UE is camped normally in the network.

When internal triggers are detected by the UE, the UE performs the cell reselection evaluation process in order to meet performance requirements.

When information on the system information used for the cell reselection evaluation process has been changed.

When the slice information obtained from non-access stratum (NAS) changes.

Additionally, the UE may be configured with dedicated cell reselection priorities for up to 8 NR carriers in the RRC release message, i.e., the UE may be configured to measure a serving NR frequency carrier and 7 NR inter-frequency carriers.

Additionally, the UE (e.g., NR UE) may receive the de-prioritization request in the RRC release message (e.g., NR RRC IE deprioritisationReq). The UE may store the received de-prioritization request until an expiry of a timer (e.g., T325, for deprioritization handling). In case the UE receives the RRC release message with the deprioritization request, the UE may consider current frequency and store frequencies due to the previously received RRC release message with the de-prioritization request or all the frequencies of the NR to be the lowest priority frequency (i.e., lower than any of the network configured values) while the timer (e.g., T325) is running.

Concerning a slice-aware cell reselection in relation to a network slice as groups (NSAG) or slice groups, the NSAG or slice group is a group that is associated with one or more slices. If the UE has indicated that the UE supports the NSAG, an access and mobility management function (AMF) may configure the UE with NSAG information for one or more single-network slice selection assistance information (S-NSSAI) in a configured NSSAI, by including the NSAG information in a registration accept message or a UE configuration command message. The AMF may indicate in the NSAG information in which tracking area (TA) a specific NSAG association to S-NSSAI(s) is valid if the AMF provides in the UE configuration an NSAG value that is used in different TAs with a different association with NSSAIs. The AMF provides a configuration that includes at least the NSAGs for the UE for one or more TAs of a registration area. Additionally, the UE may store and consider the received NSAG information is valid for registered PLMN until (a) the UE receives a new NSAG information in the registration accept message or the UE configuration command message in the registered PLMN; and/or (b) the UE receives a configured NSSAI without any NSAG information in the registered PLMN; and/or (c) NR-UE-RRC may receive the NSAG, and/or NSAG priority from an NAS layer.

Additionally, the NR-UE-RRC also may receive a list of slice information, the slice information including an identifier for the NSAG and a list of frequencies and a priority applicable for individual frequencies for the network slice. In some scenarios, there can be frequencies without priorities in the slice information and such network slices/slice groups may be considered as the lowest frequency priority for the network slice/slice group, which extracts from NR RRC 17.0.0 below illustrating the structure given in Table-1, Table-2, and Table-3.

TABLE 1
FreqPriorityListSlicing
The IE FreqPriorityListSlicing indicates cell reselection priorities for slicing in a
system information block (SIB)-16.
FreqPriorityListSlicing information element

-- ASN1START
-- TAG-FREQPRIORITYLISTSLICING-START
FreqPriorityListSlicing-r17 ::= SEQUENCE (SIZE (1..maxFreqPlus1)) OF FreqPrior-
itySlicing-r17
FreqPrioritySlicing-r17 ::= SEQUENCE {
dl-ImplicitCarrierFreq-r17 INTEGER (0..maxFreq),
sliceInfoList-r17 SliceInfoList-r17 OPTIONAL -- Need R
}
SliceInfoList-r17 ::= SEQUENCE (SIZE (1..maxSliceInfo-r17)) OF SliceInfo-r17
SliceInfo-r17 ::= SEQUENCE {
nsag-IdentityInfo-r17 NSAG-IdentityInfo-r17,
nsag-CellReselectionPriority-r17 CellReselectionPriority OPTIONAL, -- Need R
nsag-CellReselectionSubPriority-r17 CellReselectionSubPriority OPTIONAL, --
Need R
sliceCellListNR-r17 CHOICE {
sliceAllowedCellListNR-r17 SliceCellListNR-r17,
sliceExcludedCellListNR-r17 SliceCellListNR-r17
} OPTIONAL -- Need R
}
SliceCellListNR-r17 ::= SEQUENCE (SIZE (1..maxCellSlice-r17)) OF PCI-Range
-- TAG-FREQPRIORITYLISTSLICING-STOP
-- ASN1STOP

TABLE 2
FreqPriorityListSlicing field descriptions
dl-ImplicitCarrierFreq

Indicates a downlink carrier frequency to which sliceInfoList is associated with. The
frequency is signalled implicitly, value 0 corresponds to the serving frequency, value
1 corresponds to the first frequency indicated by an InterFreqCarrierFreqList in a
SIB4, and value 2 corresponds to the second frequency indicated by the InterFreqCar-
rierFreqList in the SIB4, and so on.

TABLE 3
SliceInfo field descriptions
nsag-IdentityInfo
This is the NSAG identifier of the NSAG.
sliceAllowed CellListNR
List of allow-listed neighboring cells for slicing. If present, cells not listed in this list
do not support the corresponding NSAG-frequency pair, according to the 3GPP TS
38.304 [20], clause 5.2.4.11.
sliceCellListNR
Contains either the list of allow-listed or exclude-listed neighbor cells for slicing.
sliceExcluded CellListNR
List of exclude-listed neighboring cells for slicing. If present, cells not listed in this
list support the corresponding slice nsag-frequency pair, according to the 3GPP TS
38.304 [20], clause 5.2.4.11.

Further, when the UE performs a slice-specific cell reselection, the priority used for the cell reselection is a combination of both network slice priority/NSAG priority received from the NAS and frequency priority received from the RRC messages (e.g., RRC release message). There are two ways by which the slice information (e.g., FreqPriorityNRSlicing) could be received by the UE. One by the broadcast signalling (SIB16) and the other by the dedicated signalling in the RRC messages like the RRC release message. The RRC release message may include one or more cell reselection priorities (cellReselectionPriorities) as depicted in Table-4, Table-5, Table-6, and Table-7.

TABLE 4
RRCRelease ::= SEQUENCE {
rrc-TransactionIdentifier RRC-TransactionIdentifier,
criticalExtensions CHOICE {
rrcRelease RRCRelease-IEs,
criticalExtensionsFuture SEQUENCE { }
}
}
RRCRelease-IEs ::= SEQUENCE {
redirectedCarrierInfo RedirectedCarrierInfo OPTIONAL, -- Need N
cellReselectionPriorities CellReselectionPriorities OPTIONAL, -- Need R
suspendConfig SuspendConfig OPTIONAL, -- Need R
deprioritisationReq SEQUENCE {
deprioritisationType ENUMERATED {frequency, nr},
deprioritisation Timer ENUMERATED {min5, min10, min15, min30}
} OPTIONAL, -- Need N
lateNonCriticalExtension OCTET STRING OPTIONAL,
nonCriticalExtension RRCRelease-v1540-IEs OPTIONAL
}
RRCRelease-v1540-IEs ::= SEQUENCE {
waitTime RejectWaitTime OPTIONAL, -- Need N
nonCriticalExtension RRCRelease-v1610-IEs OPTIONAL
}
RRCRelease-v1610-IEs ::= SEQUENCE {
voiceFallbackIndication-r16 ENUMERATED {true} OPTIONAL, -- Need N
measIdleConfig-r16 SetupRelease {MeasIdleConfigDedicated-r16} OPTIONAL, --
Need M
nonCriticalExtension RRCRelease-v1650-IEs OPTIONAL
}
RRCRelease-v1650-IEs ::= SEQUENCE {
mpsPriorityIndication-r16 ENUMERATED {true} OPTIONAL, -- Cond Redirection2
nonCriticalExtension SEQUENCE { } OPTIONAL
}
CellReselectionPriorities ::= SEQUENCE {
freqPriorityListEUTRA FreqPriorityListEUTRA OPTIONAL, -- Need M
freqPriorityListNR FreqPriorityListNR OPTIONAL, -- Need M
t320 ENUMERATED {min5, min10, min20, min30, min60, min120, min180, spare1}
OPTIONAL, -- Need R
...,
[[
freqPriorityListDedicatedSlicing-r17 FreqPriorityListDedicatedSlicing-r17
OPTIONAL -- Need M
]]
}

TABLE 5
FreqPriorityListDedicatedSlicing
The IE FreqPriorityListDedicatedSlicing indicates
dedicated cell reselection priorities for slicing.
FreqPriorityListDedicatedSlicing information element
-- ASN1START
-- TAG-FREQPRIORITYLISTDEDICATEDSLICING-START
FreqPriorityListDedicatedSlicing-r17 ::= SEQUENCE (SIZE (1..maxFreq)) OF Fre-
qPriorityDedicatedSlicing-r17
FreqPriority DedicatedSlicing-r17 ::= SEQUENCE {
dl-ExplicitCarrierFreq-r17 ARFCN-ValueNR,
sliceInfoListDedicated-r17 SliceInfoListDedicated-r17 OPTIONAL -- Need R
}
SliceInfoListDedicated-r17 ::= SEQUENCE (SIZE (1..maxSliceInfo-r17)) OF Slice-
InfoDedicated-r17
SliceInfoDedicated-r17 ::= SEQUENCE {
nsag-IdentityInfo-r17 NSAG-IdentityInfo-r17,
nsag-CellReselectionPriority-r17 CellReselectionPriority OPTIONAL, -- Need R
nsag-CellReselectionSubPriority-r17 CellReselectionSubPriority OPTIONAL -- Need
R
}
-- TAG-FREQPRIORITYLISTDEDICATEDSLICING-STOP
-- ASN1STOP

TABLE 6
FreqPriorityDedicatedSlicing field descriptions
dl-ExplicitCarrierFreqIndicates the downlink carrier frequency to which SliceIn-
foListDedicated is associated.

TABLE 7
SliceInfoDedicated field descriptions
nsag-IdentityInfoThis is the NSAG identifier of the NSAG.

Now, with the introduction of slicing support for the cell reselection, the UE may be configured with both a frequency priority list for NR (freqPriorityListNR) and a frequency priority list for dedicated slicing (FreqPriorityListDedicatedSlicing) in the RRC release message.

If the dedicated signalling (e.g., RRC release message), received by the UE, contains slice-specific cell reselection information for a particular frequency for a specific NSAG, but the slice-specific cell reselection information broadcasted by the serving network cell (i.e., SIB16 in NR) does not include any cell reselection priority for that frequency for the said NSAG, then the UE considers the priorities from the dedicated signalling. The UE ignores any priorities from the broadcast signalling.

If the dedicated signalling received by the UE contains the slice-specific cell reselection information for a particular frequency for a specific NSAG, but the slice-specific cell reselection information broadcasted by the serving network cell includes both the same NSAG and frequency and does not include a slice availability list for that frequency for the said NSAG, the UE considers that the NSAG is supported by all the cells in the frequency.

Concerning a slice-aware cell reselection procedure, according to 3GPP Release 17.0.0 TS 38.304, the UE derives slice-specific cell reselection priorities when the UE performs the slice-specific cell reselection, as shown below.
a. The UE determines re-selection priorities for slice-based cell reselection using at least one of the conditions listed below.
i. NSAGs and priorities of the NSAGs provided by the NAS;
ii. SliceInfoList and or sliceInfoListDedicated per frequency with nsag-CellReselectionPriority per NSAG, if provided in the system information and/or the dedicated signalling; and
iii. CellReselectionPriority per frequency provided in the system information and/or the dedicated signalling.
b. If the corresponding NSAG-ID for the NR frequency is indicated and valid for the present TA, the UE considers the NR frequency to support all network slices of the NSAG.
c. The UE considers the network cell on the NR frequency to support all network slices of the NSAG based on at least one condition listed below.
i. When the corresponding NSAG-ID is indicated for the NR frequency and valid for the current TA;
ii. When the network cell is either listed in the sliceAllowedCellListNR (if provided in the used slice specific cell reselection information) or the cell is not listed in the sliceExcludedCellListNR (if provided in the used slice specific cell reselection information); or
iii. When neither the sliceAllowedCellListNR nor the sliceExcludedCellListNR is configured in the used slice-specific cell reselection information.
d. The UE determines the re-selection priorities for the slice-based cell reselection according to one or more following rules.
i. The frequencies that support at least one prioritized NSAG received from the NAS have higher re-selection priority than the frequencies that support none of the NSAG(s) received from the NAS;
ii. The frequencies that support at least one NSAG provided by the NAS are prioritized in the order of the NAS-provided priority for the NSAG with the highest priority supported on the frequency;
iii. Among the frequencies (one or multiple) that support the highest prioritized NSAG(s) with the same NAS-provided priorities, the frequencies are prioritized in the order of their highest nsag-CellReselectionPriority given for the NSAG(s);
iv. The frequencies that support the NSAG provided by the NAS and that indicate nsag-CellReselectionPriority for the NSAG have higher re-selection priority than frequencies that support the prioritized NSAG without indicating nsag-CellReselectionPriority for the NSAG; and
v. The frequencies that support none of the NSAG(s) provided by the NAS are prioritized in the order of the CellReselectionPriority.

Additionally, the UE (e.g., NR UE) may receive the slice-specific cell reselection information through the dedicated signalling (e.g., FreqPriorityListDedicatedSlicing) and the broadcast signalling (e.g., FreqPriorityListSlicing in the SIB16). There are multiple scenarios possible with respect to the configuration of the slice-specific cell reselection information, as shown below.
e. The UE may have received the slice-specific cell reselection information through the dedicated signalling, but the slice-specific cell reselection information may not receive slice-specific reselection information through the broadcast signalling from the serving network cell. In that case, the existing system fails to provide an adequate solution for determining one or more slice-based cell reselection priorities.
f. The dedicated signalling (e.g., RRC release message) received by the UE may contain the slice-specific cell reselection information for a particular NSAG, but the slice-specific cell reselection information broadcasted by the serving network cell (e.g., SIB16) may not include that NSAG. In that case, the existing system fails to provide an adequate solution for determining one or more slice-based cell reselection priorities.
g. The dedicated signalling (e.g., RRC release message) received by the UE may contain the slice-specific cell reselection information for a particular frequency for a specific NSAG, but the slice-specific cell reselection information broadcasted by the serving network cell (e.g., SIB16) may not include that frequency for the said NSAG. In that case, the existing system fails to provide an adequate solution for determining one or more slice-based cell reselection priorities.

Further, there is a need to define a UE behaviour for the slice-specific cell reselection when cell reselection priorities (e.g., slice-specific or legacy non-slice specific) received by the UE in the dedicated signalling are deleted (e.g., after the expiry of a validity timer (T320, for dedicated priority handling) in the NR) or change of an RRC state or receiving the RRC release message with a cellreselectionPriorities field present or a PLMN selection or stand-alone non-public network (SNPN) selection requested by the NAS), or when a deprioritization is stopped.

Thus, it is desired to address the above-mentioned disadvantages or other shortcomings or at least provide a useful alternative for handling slice-based cell reselection priorities.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “slice-specific cell reselection” and “slice-based cell reselection” are used interchangeably and mean the same.

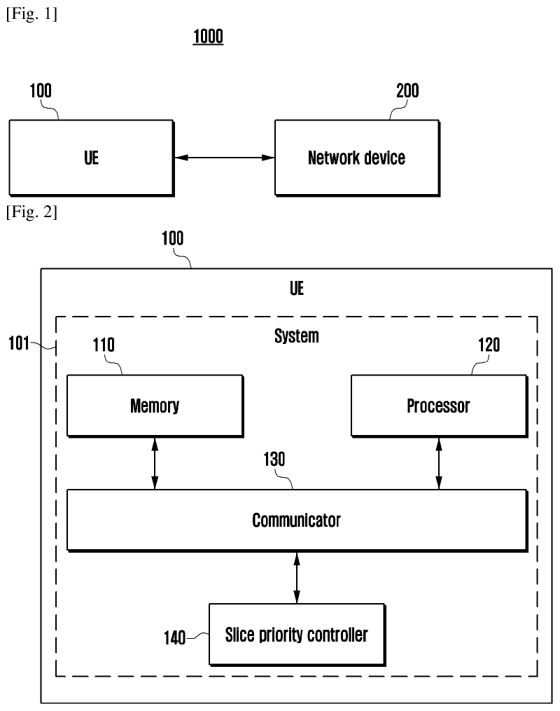

Referring now to the drawings, and more particularly to FIGS. 1 to 10, where similar reference characters denote corresponding features consistently throughout the figures, there are shown preferred embodiments.

FIG. 1 illustrates a block diagram of a system (1000) for determining one or more slice-based cell reselection priorities in a wireless network, according to an embodiment as disclosed herein. The system includes, for example, but is not limited to, a User Equipment (UE) (100) and a network device (200). Examples of the UE (100) include, but are not limited to, a smartphone, a tablet computer, a Personal Digital Assistance (PDA), an Internet of Things (IoT) device, and a wearable device. Examples of the network device (200) may include, but are not limited to, a base station, a Next Generation Node B (gNB), and a server.

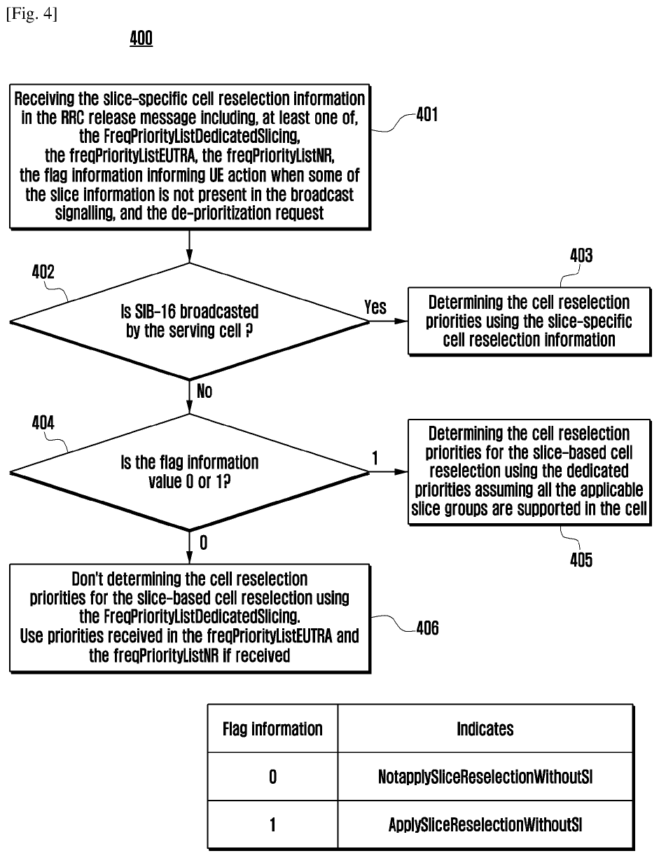

In one or more embodiments, the UE (100) is capable of a slice-specific cell reselection and needs to perform the slice-specific cell reselection based on received configurations from the network device (200) (for example is in camped normally state and has received NSAG(s) and received NSAG(s) priorities from NAS), as illustrated in FIG. 4. The UE (100) has received slice-specific cell reselection information through a dedicated signalling (e.g., received FreqPriorityListDedicatedSlicing in an RRC release message). Further, the UE (100) has not received slice-specific cell reselection information through a broadcast signalling (e.g., not received FreqPriorityListSlicing in a SIB16). In this scenario, the UE (100) does not apply the slice specific cell reselection (i.e., doesn't derive cell reselection priorities for slice-based reselection using FreqPriorityListDedicatedSlicing). Further, the UE (100) performs cell reselection only using legacy priorities (i.e. in the context of the disclosed method, non-slice specific) provided through the dedicated signalling (e.g., freqPriorityListEUTRA and freqPriorityListNR) till the dedicated slice specific cell reselection priorities are deleted. Further, if the legacy priorities are not provided through the dedicated signalling, the UE (100) doesn't perform cell reselection and moves to camped on any cell state when a current serving network cell becomes not suitable.

In one or more embodiments, consider a case when the UE (100) has received the slice-specific cell reselection information through the dedicated signalling (e.g., received FreqPriorityListDedicatedSlicing in the RRC release message). Further, the UE (100) has not received the slice-specific cell reselection information through the broadcast signalling (e.g., not received FreqPriorityListSlicing in the SIB16). In this case, the UE (100) derives the cell reselection priorities for a slice-based cell reselection considering that all the cells in all the frequencies support all the NSAGs.

In one or more embodiments, the UE (100) receives an RRC information element (IE) from the network device (200) which informs the UE (100) which alternative from the above embodiments has to be chosen. According to an embodiment, the RRC Information element (IE) is sent to the UE (100) in a dedicated RRC message (e.g., the RRC release message). In one embodiment, the RRC IE is sent to the UE (100) in a system information message (e.g., the SIB16). The IE may be included within RRC IE CellReselectionPriorities or its sub-IEs. In an embodiment, the IE may be provided within FreqPriorityListDedicatedSlicing-r17 or its sub-IEs. In an embodiment, the IE may be provided within FreqPriorityListSlicing-r17 or its sub-IEs. In an embodiment, the IE may be provided within FreqPriorityListDedicatedSlicing-r17 or its sub-IEs.

In one or more embodiments, the IE may be a flag information (flag) or an enumerated or any such IE and one value of the flag or an enumerated or any such IE. Consider a case when the flag information, in one example true or in another example false or for the enumerated in one example ApplySliceReselection WithoutSI, etc., may indicate to the UE (100). Further, the UE (100) has received the slice-specific cell reselection information through the dedicated signalling (e.g., FreqPriorityListDedicatedSlicing in the RRC release message). Also, the UE (100) has not received the slice-specific cell reselection information through the broadcast signalling (e.g., FreqPriorityListSlicing in the SIB16 or the SIB16). In this case, the UE (100) derives the cell reselection priorities for the slice-based cell reselection (one or more slice-based cell reselection priorities) considering that all the cells in all the frequencies support all the NSAGs. Consider an another case, when the UE (100) receives an another value of the flag from the network device (200). For the flag information, in one example true or in another example false or for the enumerated in one example NotapplySliceReselectionWithoutSI or other specific value, etc., may indicate to the UE (100). Further, the UE (100) has received the slice-specific cell reselection information through the dedicated signalling (e.g., FreqPriorityListDedicatedSlicing the RRC release message). Also, the UE (100) has not received the slice-specific cell reselection information through the broadcast signalling (e.g., FreqPriorityListSlicing in the SIB16 or the SIB16). In this case, the UE (100) does not apply slice specific cell reselection (i.e., doesn't derive cell reselection priorities for slice-based reselection using FreqPriorityListDedicatedSlicing), but performs cell reselection only using the legacy (i.e., in the context of the disclosed method, non-slice specific) priorities provided through the dedicated signalling (e.g., freqPriorityListEUTRA and freqPriorityListNR).

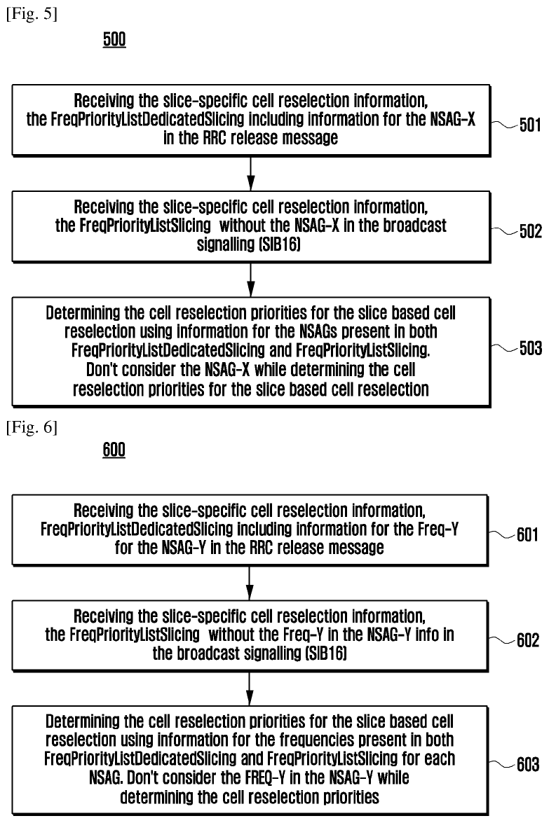

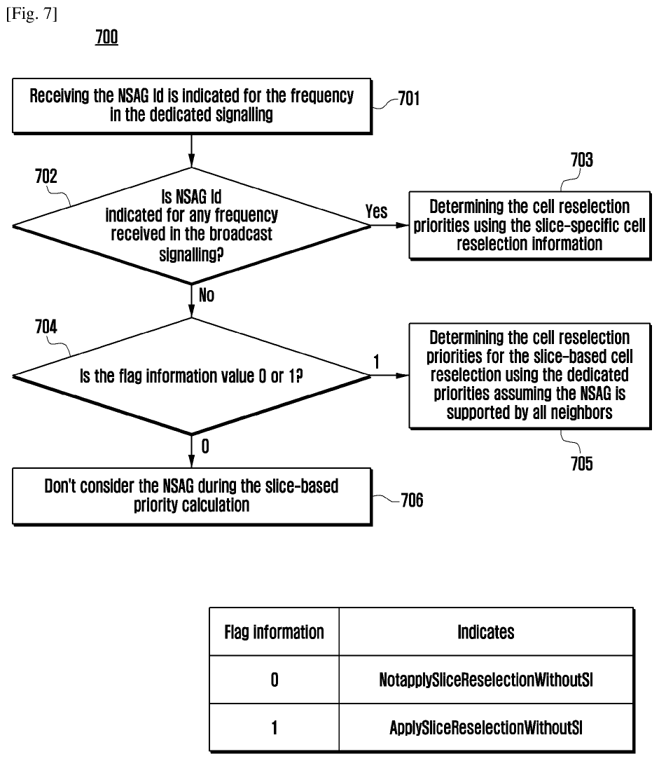

Furthermore, the present subject matter discloses that when the RRC release message received by the UE (100) contains the slice-specific cell reselection information for an NSAG (e.g., NSAG-X), but the slice-specific cell reselection information broadcasted by the serving network cell may not include that NSAG (i.e., NSAG-X). In this case, the UE (100) derives cell reselection priorities for the slice-based cell reselection without considering that NSAG (i.e., NSAG-X), as illustrated in FIG. 5 and FIG. 7. In other words, while deriving cell reselection priorities for the slice-based cell reselection, the UE (100) considers that the NSAG-X is not supported by any frequency or any network cell. The UE (100) then ignores SliceInfoDedicated for the NSAG-X for all frequencies received through the dedicated signalling during the derivation of cell reselection priorities for the slice-based cell reselection. This also means that the UE (100) considers only the NSAGs that are present in both dedicated signalling and broadcast signalling for deriving cell reselection priorities for the slice-based cell reselection.

In one or more embodiments, consider a case when the RRC release message received by the UE (100) contains the slice-specific cell reselection information for the NSAG (e.g., NSAG-X), but the slice-specific cell reselection information broadcasted by the serving network cell may not include that NSAG (i.e., NSAG-X). In this case, the UE (100) derives cell reselection priorities for the slice-based cell reselection considering that the NSAG-X is supported by all frequencies for all neighbor network cells.

In one or more embodiments, the UE (100) receives the RRC IE from the network device (200) which informs the UE (100) which alternative from the above embodiments (e.g., NSAG-X) has to be chosen. In an embodiment, the RRC IE is sent to the UE (100) in the dedicated RRC message (e.g., the RRC release message). In an embodiment, the RRC IE is sent to the UE (100) in the system information message (e.g., the SIB16). In an embodiment, the IE may be included within the RRC IE CellReselectionPriorities or its sub-IEs. In an embodiment, the RRC IE may be provided within the FreqPriorityListDedicatedSlicing-r17 or its sub-IEs. In an embodiment, the RRC IE may be provided within the FreqPriorityListSlicing-r17 or its sub-IEs. In an embodiment, the RRC IE may be provided within the FreqPriorityListDedicatedSlicing-r17 or its sub-IEs.

In one or more embodiments, the IE may be the flag information or an enumerated or any such IE and one value of the flag or enumerated or any such IE. Consider a case when the flag information, in one example true or in another example false or for the enumerated in one example NotapplySliceReselection WithoutSI or other specific value, etc., may indicate to the UE (100) via the RRC release message. In this case, when the UE (100) determines that the slice-specific cell reselection information for the NSAG (e.g., NSAG-X) is included in the dedicated signalling, but the slice-specific cell reselection information broadcasted by the serving network cell may not include that NSAG (i.e., NSAG-X). Then, the UE (100) derives cell reselection priorities for slice-based cell reselection without considering that NSAG (i.e., NSAG-X). In another case, when the UE (100) receives an another value of the flag information or an enumerated or any such IE may be provided. For the flag, in one example true or in another example false or for the enumerated in one example applySliceReselectionWithoutSI or other specific value, etc., may indicate the when the RRC release message received by the UE (100). In this case, when the UE (100) determines that slice specific cell reselection information for the NSAG (e.g., NSAG-X) is included in the dedicated signalling, but the slice-specific cell reselection information broadcasted by the serving network cell may not include that NSAG (i.e., NSAG-X). Then, the UE (100) derives cell reselection priorities for the slice-based cell reselection considering that the NSAG-X is supported by all frequencies for all neighbors (neighbor cells).

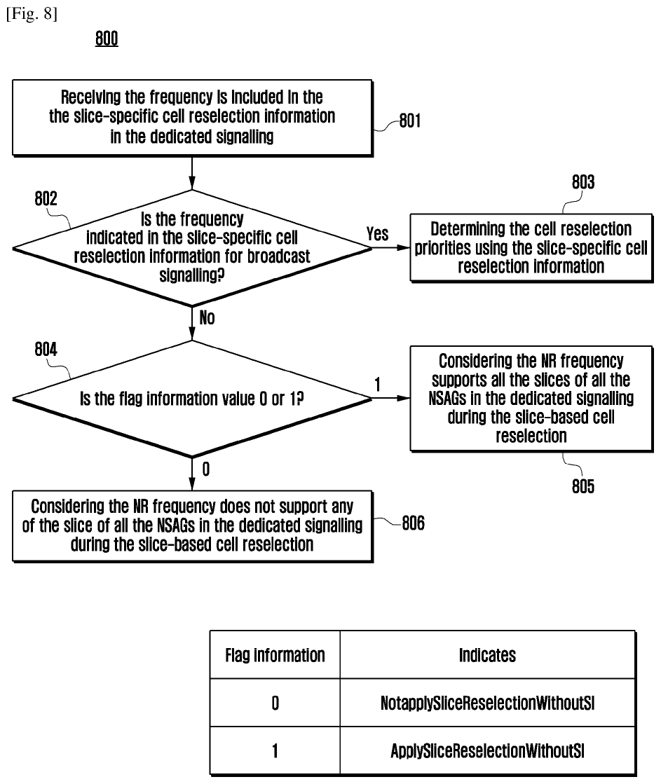

Furthermore, the present subject matter discloses that when the RRC release message received by the UE (100) contains the slice-specific cell reselection information for a frequency (e.g., Freq-Y) for an NSAG (e.g., NSAG-Y), but the slice-specific cell reselection information broadcasted by the serving network cell may not include that frequency (i.e., Freq-Y) for that NSAG (i.e., NSAG-Y), the UE (100) derives the cell reselection priorities for slice-based cell reselection without considering that frequency (i.e., Freq-Y) for that NSAG (i.e., NSAG-Y), as illustrated in FIG. 6 and FIG. 8. In other words, while deriving the cell reselection priorities for the slice-based cell reselection, the UE (100) considers that NSGA-Y is not supported by the Freq-Y or any cell on the Freq-Y. The UE (100) ignores the SliceInfoDedicated for the NSAG-X for the Freq-Y received through the dedicated signalling during the derivation of cell reselection priorities for slice-based cell reselection. This also means that UE considers, for any NSAG, the frequencies that are present in both dedicated signalling and broadcast signalling for deriving the cell reselection priorities for the slice-based cell reselection.

In one or more embodiments, consider a case when the RRC release message received by the UE (100) contains the slice-specific cell reselection information for the frequency (e.g., Freq-Y) for the NSAG (e.g., NSAG-Y), but the slice-specific cell reselection information broadcasted by the serving network cell may not include that frequency (i.e., Freq-Y) for that NSAG (i.e., NSAG-Y). In this case, the UE (100) derives the cell reselection priorities for the slice-based cell reselection considering that the Freq-Y supports the NSAG-Y.

In one or more embodiments, the UE (100) receives the RRC IE from the network device (200) which informs the UE (100) which alternative from the above embodiments (e.g., Freq-Y for NSAG-Y) has to be chosen. In an embodiment, the RRC IE is sent to the UE (100) in the dedicated RRC message (e.g., the RRC release message). In an embodiment, the RRC IE is sent to the UE (100) in the system information message (e.g., the SIB16). In an embodiment, the IE may be included within the RRC IE CellReselectionPriorities or its sub-IEs. In an embodiment, the RRC IE may be provided within the FreqPriorityListDedicatedSlicing-r17 or its sub-IEs. In an embodiment, the RRC IE may be provided within the FreqPriorityListSlicing-r17 or its sub-IEs. In an embodiment, the RRC IE may be provided within the FreqPriorityListDedicatedSlicing-r17 or its sub-IEs.

In one or more embodiments, the IE may be the flag information or an enumerated or any such IE and one value of the flag information or enumerated or any such IE. Consider a case when the flag information, in one example true or in another example false or for the enumerated in one example NotApplySliceReselection WithoutSI or other specific value, etc., may indicate to the UE (100) via the RRC release message. In this case, when the UE (100) determines that the slice-specific cell reselection information for the frequency (e.g., Freq-Y) for the NSAG (e.g., NSAG-Y) is included in the dedicated signalling, but the slice-specific cell reselection information broadcasted by the serving network cell may not include that frequency (i.e., Freq-Y) for that NSAG (i.e., NSAG-Y). In this case, the UE (100) derives the cell reselection priorities for the slice-based cell reselection without considering that frequency (i.e., Freq-Y) for that NSAG (i.e., NSAG-Y). Consider another case, when the UE (100) receives an another value of the flag information or an enumerated or any such IE (for the flag information, in one example true or in another example false or for the enumerated in one example applySliceReselection WithoutSI or other specific value, etc.) may indicate to the UE (100) via the RRC release message. In this case, when the UE (100) determines that slice-specific cell reselection information for the frequency (e.g., Freq-Y) for the NSAG (e.g., NSAG-Y) is included in the dedicated signalling, but the slice-specific cell reselection information broadcasted by the serving network cell may not include that frequency (i.e., Freq-Y) for that NSAG (i.e., NSAG-Y). In this case, the UE (100) derives the cell reselection priorities for the slice-based cell reselection considering that Freq-Y (all cells of Freq Y) supports the NSAG-Y.

In one embodiment, when dedicated slice-specific information is available, the UE (100) considers an NR frequency to support all slices of an NSAG only if the corresponding NSAG-ID is indicated for the NR frequency and is valid for the current TA in both dedicated slice-specific information and the system information of the serving network cell. In one embodiment, when the dedicated slice-specific information is available, the UE (100) considers an NR cell to support all slices of an NSAG only when the corresponding NSAG-ID is indicated for the NR frequency and is valid for current TA in both dedicated slice-specific information and the system information of the serving network cell. In one embodiment, the UE (100) derives the slice-specific reselection priorities only for the frequencies and NSAGs provided in the system information.

The disclosed methodology may be captured in 3GPP TS 38.304 (with the baseline as v17.1.0) as the UE (100) may derive reselection priorities according to clause 5.2.4.11 only for the frequencies and NSAGs provided in system information.” Alternatively, the UE (100) may derive reselection priorities according to clause 5.2.4.11 only if the SIB16 is available and only for the frequencies and NSAGs provided in the SIB16.

Similarly, in section 5.2.4.11 of TS 38.304, the UE (100) considers an NR frequency to support all slices of an NSAG if the corresponding NSAG-ID is indicated for the NR frequency and valid for the current TA (when dedicated slice-specific information is available, in both dedicated slice-specific information and the system information of the serving network cell).

Additionally, the UE (100) considers a cell on an NR frequency to support all slices of an NSAG if the corresponding NSAG-ID is indicated for the NR frequency and valid for the current TA (when dedicated slice-specific information is available, in both dedicated slice-specific information and the system information of the serving network cell).

Additionally, for the UE (100) that has received dedicated cell reselection-related information and when the dedicated cell reselection-related information is deleted (e.g. cell reselection priorities provided by dedicated signalling is deleted, e.g. after the expiry of validity timer (T320 in NR) or change of RRC state or receiving RRC release message with field cellreselectionPriorities present or a PLMN selection or SNPN selection requested by NAS), the UE (100) derives or re-derives the cell reselection priorities for slice-based reselection.

The disclosed methodology may be captured in 3GPP TS 38.304 (with the baseline as v17.1.0) as the UE (100) may delete priorities provided by dedicated signalling and if applicable derive the cell reselection priorities according to section 5.2.4.11 when the UE (100) enters a different RRC state; or the optional validity time of dedicated priorities (T320) expires; or the UE (100) receives the RRC release message with the field cellReselectionPriorities absent; or a PLMN selection or SNPN selection is performed on request by the NAS (TS 23.122 [9]). Additionally, noted that equal priorities between RATs are not supported. For example, when the cellReselectionPriorities contain a NR frequency and a E-ULTRA frequency, they have different priorities.

Further, the UE (100) that has received a de-prioritization request (deprioritisationReq) (i.e., the UE (100) has received the RRC release message with deprioritisationReq) and has applied de-prioritization, when the de-prioritization is stopped (e.g., T325 has expired), the UE (100) derives or re-derives the cell reselection priorities for the slice-based reselection.

The disclosed methodology may be captured in 3GPP TS 38.304 (with the baseline as v17.1.0) as in case the UE (100) receives the RRC release message with the deprioritization request, the UE (100) may consider the current frequency and stored frequencies due to the previously received RRC release message with the de-prioritization request or all the frequencies of NR to be the lowest priority frequency (i.e., lower than any of the network configured values) while the T325 is running irrespective of camped RAT. If applicable, the UE (100) may derive the slice-specific cell reselection priorities on stopping the de-prioritization. The UE (100) may delete the stored prioritization request(s) when the PLMN selection or SNPN selection is performed on request by the NAS (TS 23.122 [9]).

Additionally, if the system information message is applicable for the slice-specific cell reselection (e.g., the SIB16) changes, the UE (100) restarts the cell reselection evaluation process. The UE (100) may derive the cell reselection priorities and restart the measurements.

Additionally, if the UE (100) has re-derived cell reselection priorities for the slice-based cell reselection considering only a subset of slices supported by the network cell (e.g., best cell or highest ranked cell), the UE (100) derives cell reselection priorities considering all the slices supported by the frequency when information on a broadcast control channel (BCCH) used for the cell reselection evaluation procedure has been modified.

The disclosed methodology may be captured in the RRC idle mode specification of 3GPP TS 38.304 (with the baseline as v17.1.0) as when the best and highest ranked cell does not support the highest priority slice, the UE (100) rederives the cell reselection priorities and the rederived priority is used for a maximum of 300 seconds or until a new slice or slice group information of NSAG(s) and their priorities are received from the NAS or when information on the BCCH used for the cell reselection evaluation procedure has been modified.”

In an embodiment, a common flag (or enumerated or any such IE) is used for embodiments A1, A2, and A3, relates to the RRC idle mode specification of 3GPP TS 38.304 (with the baseline as v17.1.0). The UE (100) may receive a single IE in the RRC message (flag or enumerated or any such IE) applicable for all the scenarios in embodiments A1, A2, and A3.

In one or more embodiments, the use of Information Elements (IEs) specifically designed for the New Radio (NR) technology. It is worth noting that similar IEs may also exist in other technologies, such as 6G. The purpose of these IEs is to enable the efficient exchange of information between different network elements, facilitating the proper functioning of the network.

FIG. 2 illustrates a block diagram of the UE (100) for determining the one or more slice-based cell reselection priorities in the wireless network, according to an embodiment as disclosed herein. In an embodiment, the UE (100) comprises a system (101). The system (101) may include a memory (110), a processor (120), a communicator (130), and a slice priority controller (140).

In an embodiment, the memory (110) stores instructions to be executed by the processor (120) for determining one or more slice-based cell reselection priorities in a wireless network, as discussed throughout the disclosure. The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit, or it can be an external storage unit of the UE (100), a cloud storage, or any other type of external storage.

The processor (120) communicates with the memory (110), the communicator (130), and the slice priority controller (140). The processor (120) is configured to execute instructions stored in the memory (110) and to perform various processes for determining one or more slice-based cell reselection priorities in a wireless network, as discussed throughout the disclosure. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g., the network device (200)) via one or more networks (e.g., Radio technology). The communicator (130) includes an electronic circuit specific to a standard that enables wired or wireless communication.

The slice priority controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the slice priority controller (140) receives one or more configurations of the slice-specific cell reselection information in a Radio Resource Control (RRC) release message from a network device (200) through the dedicated signalling. The one or more received configurations comprise at least one of a frequency priority list for dedicated slicing (e.g., FreqPriorityListDedicatedSlicing) information including a list of frequencies, a list of associated NSAG for each frequency and a cell reselection priority for the NSAG, a frequency priority list for evolved universal terrestrial radio access (e.g., freqPriorityListEUTRA) information, a frequency priority list for new radio (e.g., freqPriorityListNR) information, the flag information, and a deprioritization request.

In one or more embodiments, the slice priority controller (140) receives one or more configurations of the slice-specific cell reselection information in the broadcast signalling comprising a System Information Block (SIB) from the network device (200). The SIB-16 comprises at least one of a frequency priority list slicing (FreqPriorityListSlicing) information including a list of frequencies, a list of associated NSAG for each frequency and a cell reselection priority for an NSAG, a list of allow-listed neighboring cells for slicing and a list of exclude-listed neighboring cells for slicing.

In one or more embodiments, the slice priority controller (140) determines that one or more Network Slice AS Groups (NSAG) frequency pairs of the one or more received configurations associated with the dedicated signalling are unavailable in the one or more received configurations associated with the broadcast signalling. Based on the determination that the one or more NSAG frequency pairs of the one or more received configurations associated with the dedicated signalling are unavailable in the one or more received configurations associated with the broadcast signalling, the slice priority controller (140) determines the one or more slice-based cell reselection priorities using one of operation listed below.

The slice priority controller (140) determines the one or more slice-based cell reselection priorities from the one or more NSAG frequency pairs that are present in both the dedicated signalling and the broadcast signalling, without utilizing the one or more NSAG frequency pairs of the one or more received configurations associated with the dedicated signalling that is unavailable in the broadcast signalling; or

The slice priority controller (140) determines the one or more slice-based cell reselection priorities based on a consideration that all the cells in the frequency in the one or more NSAG frequency pairs of the one or more received configurations in the dedicated signalling support the NSAG in the one or more NSAG frequency pairs.

In one or more embodiments, the slice priority controller (140) receives the flag information from the network device (200). The slice priority controller (140) then determines whether the received flag information indicates information related to an application of slice reselection without system information (i.e., ApplySliceReselectionWithoutSI) or information related to refraining of the application of slice reselection without system information (i.e., NotapplySliceReselection WithoutSI). The slice priority controller (140) then performs one of the operations listed below.

The slice priority controller (140) then determines the one or more slice-based cell reselection from the one or more NSAG frequency pairs that are present in both the dedicated signalling and the broadcast signalling, without utilizing the one or more NSAG frequency pairs associated with the dedicated signalling that is unavailable in the broadcast signalling in response to determining that the flag information indicates that the information related to the application of slice reselection without system information; or

The slice priority controller (140) then determines the one or more slice-based cell reselection priorities based on the consideration that all the cells in the frequency in the one or more NSAG frequency pairs associated with the one or more received configurations in the dedicated signalling support the NSAG in the one or more NSAG frequency pairs in response to determining that the flag information indicates that the information related to refraining of the application of slice reselection without system information.

In one or more embodiments, the slice priority controller (140) determines that a frequency priority list for dedicated slicing (e.g., FreqPriorityListDedicatedSlicing) information comprises information for a particular NSAG (e.g., NSAG-X) in the received RRC release message. The slice priority controller (140) then determines that frequency priority list slicing (e.g., FreqPriorityListSlicing) information excludes the particular NSAG (e.g., NSAG-X) in the received SIB. The slice priority controller (140) then determines the one or more slice-based cell reselection priorities using the NSAG information associated with the frequency priority list for dedicated slicing (e.g., FreqPriorityListDedicatedSlicing) information and the frequency priority list slicing (e.g., FreqPriorityListSlicing) information, without utilizing the particular NSAG (e.g., NSAG-X).

In one or more embodiments, the slice priority controller (140) determines that a frequency priority list for dedicated slicing (e.g., FreqPriorityListDedicatedSlicing) information comprises information for a particular frequency (e.g., Freq-Y) for a particular NSAG (e.g., NSAG-Y) in the received RRC release message. The slice priority controller (140) then determines that frequency priority list slicing (e.g., FreqPriorityListSlicing) information excludes the particular frequency (e.g., Freq-Y) for the particular NSAG (e.g., NSAG-Y) in the received SIB. The slice priority controller (140) then determines the one or more slice-based cell reselection priorities using the frequency presented in both the frequency priority list for dedicated slicing (e.g., FreqPriorityListDedicatedSlicing) information and the frequency priority list slicing (e.g., FreqPriorityListSlicing) information, without utilizing the particular frequency (e.g., Freq-Y) for the particular NSAG (e.g., NSAG-Y).

In one or more embodiments, the slice priority controller (140) performs a deprioritisation operation based on a deprioritisation request received in the RRC release message. The slice priority controller (140) then detects an expiration of a timer. The slice priority controller (140) then stops the deprioritisation operation upon the expiration of the timer. The slice priority controller (140) then determines or re-determines the one or more slice-based cell reselection priorities based on the received slice-specific cell reselection information.

In one or more embodiments, the slice priority controller (140) performs a cell reselection operation using one or more dedicated cell reselection priorities. The slice priority controller (140) then deletes the one or more dedicated cell reselection priorities based on one or more events. The slice priority controller (140) then determines or re-determines the one or more slice-based cell reselection priorities based on the received slice-specific cell reselection information associated with the broadcast signalling.

Although FIG. 2 shows various hardware components of the UE (100), but it is to be understood that other embodiments are not limited thereon. In other embodiments, the UE (100) may include less or more number of components. Further, the labels or names of the components are used only for illustrative purpose and does not limit the scope of the invention. One or more components can be combined to perform the same or substantially similar functions to determine the one or more slice-based cell reselection priorities in the wireless network.

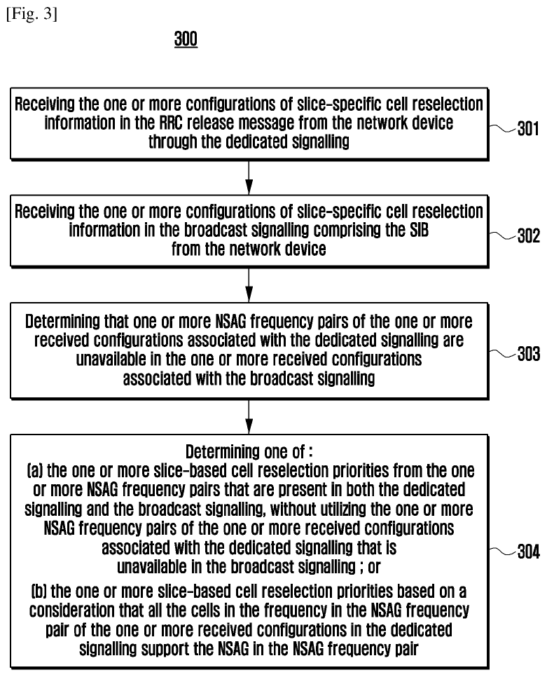

FIG. 3 is a flow diagram illustrating a method (300) for determining the one or more slice-based cell reselection priorities in the wireless network, according to an embodiment as disclosed herein.

At step 301, the method (300) includes receiving the one or more configurations of slice-specific cell reselection information in the RRC release message from the network device (200) through the dedicated signalling. In one embodiment, the one or more received configurations comprise at least one of the frequency priority list for dedicated slicing (e.g., FreqPriorityListDedicatedSlicing) information including the list of frequencies, the list of associated NSAG for each frequency and the cell reselection priority for the NSAG, the frequency priority list for evolved universal terrestrial radio access (e.g., freqPriorityListEUTRA) information, the frequency priority list for new radio (e.g., freqPriorityListNR) information, the flag information, and the deprioritisation request.

At step 302, the method (300) includes receiving the one or more configurations of slice-specific cell reselection information in the broadcast signalling comprising the SIB from the network device (200). In one embodiment, the SIB-16 comprises at least one of the frequency priority list slicing (e.g., FreqPriorityListSlicing) information including the list of frequencies, the list of associated NSAG for each frequency and the cell reselection priority for the NSAG, the list of allow-listed neighboring cells for slicing and the list of exclude-listed neighboring cells for slicing.

At step 303, the method (300) includes determining that the one or more Network Slice As Groups (NSAG) frequency pairs of the one or more received configurations associated with the dedicated signalling are unavailable in the one or more received configurations associated with the broadcast signalling.

At step 304, the method (300) includes determining, based on the determination that the one or more NSAG frequency pairs of the one or more received configurations associated with the dedicated signalling are unavailable in the one or more received configurations associated with the broadcast signalling and the one or more received configurations of slice-specific cell reselection information in the RRC release message, using one of operation listed below.

The method (300) includes determining the one or more slice-based cell reselection priorities from the one or more NSAG frequency pairs that are present in both the dedicated signalling and the broadcast signalling, without utilizing the one or more NSAG frequency pairs of the one or more received configurations associated with the dedicated signalling that is unavailable in the broadcast signalling; or

The method (300) includes determining the one or more slice-based cell reselection priorities based on a consideration that all the cells in the frequency in the one or more NSAG frequency pairs of the one or more received configurations in the dedicated signalling support the NSAG in the one or more NSAG frequency pairs.

In one or more embodiments, the method (300) includes receiving the flag information from the network device (200). The method (300) includes determining whether the received flag information indicates information related to an application of slice reselection without system information (i.e., ApplySliceReselection WithoutSI) or information related to refraining of the application of slice reselection without system information (i.e., NotapplySliceReselection WithoutSI). The method (300) includes performing one of the operations listed below.

The method (300) includes determining the one or more slice-based cell reselection from the one or more NSAG frequency pairs that are present in both the dedicated signalling and the broadcast signalling, without utilizing the one or more NSAG frequency pairs associated with the dedicated signalling that is unavailable in the broadcast signalling in response to determining that the flag information indicates that the information related to the application of slice reselection without system information; or

The method (300) includes determining the one or more slice-based cell reselection priorities based on the consideration that all the cells in the frequency in the one or more NSAG frequency pairs associated with the one or more received configurations in the dedicated signalling support the NSAG in the one or more NSAG frequency pairs in response to determining that the flag information indicates that the information related to refraining of the application of slice reselection without system information.

In one or more embodiments, the method (300) includes determining that the frequency priority list for dedicated slicing (e.g., FreqPriorityListDedicatedSlicing) information comprises information for the particular NSAG (e.g., NSAG-X) in the received RRC release message. The method (300) includes determining that frequency priority list slicing (e.g., FreqPriorityListSlicing) information excludes the particular NSAG (e.g., NSAG-X) in the received SIB. The method (300) includes determining the one or more slice-based cell reselection priorities using the NSAG information associated with the frequency priority list for dedicated slicing (e.g., FreqPriorityListDedicatedSlicing) information and the frequency priority list slicing (e.g., FreqPriorityListSlicing) information, without utilizing the particular NSAG (e.g., NSAG-X).

In one or more embodiments, the method (300) includes determining that the frequency priority list for dedicated slicing (e.g., FreqPriorityListDedicatedSlicing) information comprises information for the particular frequency (e.g., Freq-Y) for the particular NSAG (e.g., NSAG-Y) in the received RRC release message. The method (300) includes determining that frequency priority list slicing (e.g., FreqPriorityListSlicing) information excludes the particular frequency (e.g., Freq-Y) for the particular NSAG (e.g., NSAG-Y) in the received SIB. The method (300) includes determining the one or more slice-based cell reselection priorities using the frequency presented in both the frequency priority list for dedicated slicing (e.g., FreqPriorityListDedicatedSlicing) information and the frequency priority list slicing (e.g., FreqPriorityListSlicing) information, without utilizing the particular frequency (e.g., Freq-Y) for the particular NSAG (e.g., NSAG-Y).

In one or more embodiments, the method (300) includes performing the deprioritisation operation based on the deprioritisation request received in the RRC release message. The method (300) includes detecting the expiration of the timer. The method (300) includes stopping the deprioritisation operation upon the expiration of the timer. The method (300) includes determining or re-determining the one or more slice-based cell reselection priorities based on the received slice-specific cell reselection information.

In one or more embodiments, the method (300) includes performing the cell reselection operation using one or more dedicated cell reselection priorities. The method (300) includes deleting the one or more dedicated cell reselection priorities based on one or more events. The method (300) includes determining or re-determining the one or more slice-based cell reselection priorities based on the received slice-specific cell reselection information associated with the broadcast signalling.

FIG. 4 illustrates an operational flow diagram illustrating a method (400) for performing the slice-specific cell reselection when the slice-specific cell reselection information is received from the network device (200) via the dedicated signalling but not via the broadcast signalling (e.g., system information (SIB-16)), according to an embodiment as disclosed herein.

The method (400) has been developed to carry out slice-specific cell reselection in cases where the slice-specific cell reselection data is transmitted through the dedicated signalling rather than the broadcast signalling, such as system information (e.g., SIB16). The method (400) enables the device to make informed decisions about which cell to select based on the received slice-specific cell reselection information. The method (400) involves analyzing data (e.g., one or more configurations of slice-specific cell reselection information) received from the network device (200) and making a selection based on the provided data, a step-by-step procedure for the same is shown below. The method (400) is designed to ensure that the UE (100) remains connected to the appropriate network slice, thereby improving the overall quality of service.

At step 401, the method (400) includes receiving the slice-specific cell reselection information in the RRC release message including, at least one of, the FreqPriorityListDedicatedSlicing, the freqPriorityListEUTRA, the freqPriorityListNR, the flag information informing UE action when some of the slice information is not present in the broadcast signalling, and the de-prioritization request, which relates to step 301 of FIG. 3.

At step 402, the method (400) includes determining whether the slice-specific cell reselection information is received in the broadcast signalling (e.g., FreqPriorityListSlicing in the SIB16), which relates to step 302 of FIG. 3.

At step 403, the method (400) includes determining the cell reselection priorities using the slice-specific cell reselection information in response to determining that the slice-specific cell reselection information is received in the broadcast signalling, which relates to step 304 of FIG. 3.

At step 404, the method (400) includes determining whether the flag information is received from the network device (200) in response to determining that the slice-specific cell reselection information is not received in the broadcast signalling, which relates to step 304 of FIG. 3. The flag information includes, in one example true or in another example false or for the enumerated in one example ApplySliceReselectionWithoutSI (flag value set as “1”), NotApplySliceReselection WithoutSI (flag value set as “0”), etc.)

At step 405, the method (400) includes determining the cell reselection priorities for the slice-based cell reselection using the dedicated priorities assuming all the applicable slice groups are supported in the cell in response to determining that the flag information (i.e., ApplySliceReselection WithoutSI) is received from the network device (200), which relates to step 304 of FIG. 3.

At step 406, the method (400) includes not determining the cell reselection priorities for the slice-based cell reselection using the FreqPriorityListDedicatedSlicing or determine the cell reselection priorities for the slice-based cell reselection using the priorities received in the freqPriorityListEUTRA and the freqPriorityListNR if received, in response to determining that the flag information (i.e., NotApplySliceReselection WithoutSI) is received from the network device (200), which relates to step 304 of FIG. 3.

FIG. 5 illustrates an operational flow diagram illustrating a method (500) for performing the slice-specific cell reselection when slice-specific cell reselection information for the NSAG is received from the network device (200) via the dedicated signalling but not via the broadcast signalling, according to an embodiment as disclosed herein.

The method (500) for conducting the slice-specific cell reselection in cases where the relevant information (i.e., slice-specific cell reselection information) for the NSAG is provided by the network device (200) through the dedicated signalling rather than the broadcast signalling. The method (500) involves a targeted approach to cell reselection that is informed by the received information (i.e., slice-specific cell reselection information), a step-by-step procedure for the same is shown below. By using the method (500), network operators can ensure that the appropriate cells are selected for the NSAG, leading to improved network performance and user experience.

At step 501, the method (500) includes receiving the slice-specific cell reselection information, the FreqPriorityListDedicatedSlicing including information for the NSAG-X in the RRC release message, which relates to step 301 of FIG. 3.

At step 502, the method (500) includes receiving the slice-specific cell reselection information, the FreqPriorityListSlicing without the NSAG-X in the broadcast signalling (SIB16), which relates to step 302 of FIG. 3.

At step 503, the method (500) includes determining the cell reselection priorities for the slice-based cell reselection using information for the NSAGs present in both FreqPriorityListDedicatedSlicing and FreqPriorityListSlicing, which relates to step 304 of FIG. 3. The method (500) further includes not considering the NSAG-X while determining the cell reselection priorities for the slice-based cell reselection. In other words, the NSAG-X may not be considered while determining the priorities for the slice-based cell reselection.

FIG. 6 illustrates an operational flow diagram illustrating a method (600) for performing the slice-specific cell reselection when slice-specific cell reselection information for the frequency for the NSAG is received from the network device via the dedicated signalling but not via the broadcast signalling, according to an embodiment as disclosed herein.

The method (600) for conducting the slice-specific cell reselection based on information (i.e., slice-specific cell reselection information) received from the network device (200) through the dedicated signalling, rather than the broadcast signalling. The method (600) allows for more targeted and efficient cell reselection, as the method (600) considers the specific needs of the frequency for the NSAG, a step-by-step procedure for the same is shown below. By leveraging the slice-specific information, the method (600) enables improved network performance and a more seamless user experience.

At step 601, the method (600) includes receiving the slice-specific cell reselection information, the FreqPriorityListDedicatedSlicing including information for the Freq-Y for the NSAG-Y in the RRC release message, which relates to step 301 of FIG. 3.

At step 602, the method (600) includes receiving the slice-specific cell reselection information, the FreqPriorityListSlicing without the Freq-Y in the NSAG-Y info in the broadcast signalling (e.g., SIB16), which relates to step 302 of FIG. 3.

At step 603, the method (600) includes determining the cell reselection priorities for the slice-based cell reselection using information for the frequencies present in both FreqPriorityListDedicatedSlicing and FreqPriorityListSlicing for each NSAG, which relates to step 304 of FIG. 3. The method (600) further includes not considering the FREQ-Y in the NSAG-Y while determining the cell reselection priorities. In other words, the FREQ-Y in the NSAG-Y may not be considered while determining the priorities for the slice-based cell reselection.

FIG. 7 illustrates an operational flow diagram illustrating a method (700) for determining that the NSAG is supported by the frequency, according to an embodiment as disclosed herein.

At step 701, the method (700) includes receiving the NSAG ID indicated for the frequency in the dedicated signalling, which relates to step 301 of FIG. 3.

At step 702, the method (700) includes determining whether the NSAG ID is indicated for any frequency received in the broadcast signalling, which relates to step 302 of FIG. 3.

At step 703, the method (700) includes determining the cell reselection priorities using the slice-specific cell reselection information in response to determining that the NSAG ID is indicated for any frequency received in the broadcast signalling, which relates to step 304 of FIG. 3.

At step 704, the method (700) includes determining whether the flag information is received from the network device (200) in response to determining that the slice-specific cell reselection information is not received in the broadcast signalling, which relates to step 304 of FIG. 3. The flag information includes, in one example true or in another example false or for the enumerated in one example ApplySliceReselectionWithoutSI (flag value set as “1”) NotApplySliceReselection WithoutSI (flag value set as “0”, etc.)

At step 705, the method (700) includes determining the cell reselection priorities for the slice-based cell reselection using the dedicated priorities assuming the NSAG is supported by all neighbor cells in response to determining that the flag information (i.e., ApplySliceReselection WithoutSI) is received from the network device (200), which relates to step 304 of FIG. 3.

At step 706, the method (700) includes determining the cell reselection priorities for the slice-based cell reselection without utilizing the NSAG in response to determining that the flag information (i.e., NotApplySliceReselection WithoutSI) is received from the network device (200), which relates to step 304 of FIG. 3.

FIG. 8 illustrates an operational flow diagram illustrating a method (800) for determining that the NSAG is supported by the frequency, according to an embodiment as disclosed herein.

At step 801, the method (800) includes receiving the frequency is included in the slice-specific cell reselection information in the dedicated signalling, which relates to step 301 of FIG. 3.

At step 802, the method (800) includes determining whether the frequency is indicated in the slice-specific cell reselection information for the broadcast signalling, which relates to step 302 of FIG. 3.

At step 803, the method (800) includes determining the cell reselection priorities using the slice-specific cell reselection information in response to determining that the frequency is indicated in the slice-specific cell reselection information for the broadcast signalling, which relates to step 304 of FIG. 3.

At step 804, the method (800) includes determining whether the flag information is received from the network device (200) in response to determining that the frequency is not indicated in the slice-specific cell reselection information for the broadcast signalling, which relates to step 304 of FIG. 3. The flag information includes, in one example true or in another example false or for the enumerated in one example ApplySliceReselection WithoutSI (flag value set as “1”), NotApplySliceReselectionWithoutSI (flag value set as “0”), etc.

At step 805, the method (800) includes considering the NR frequency supports all the slices of all the NSAGs in the dedicated signalling during the slice-based cell reselection in response to determining that the flag information (i.e., ApplySliceReselection WithoutSI) is received from the network device (200), which relates to step 304 of FIG. 3.

At step 806, the method (800) includes considering the NR frequency does not support any of the slices of all the NSAGs in the dedicated signalling during the slice-based cell reselection in response to determining that the flag information (i.e., NotApplySliceReselection WithoutSI) is received from the network device (200), which relates to step 304 of FIG. 3.

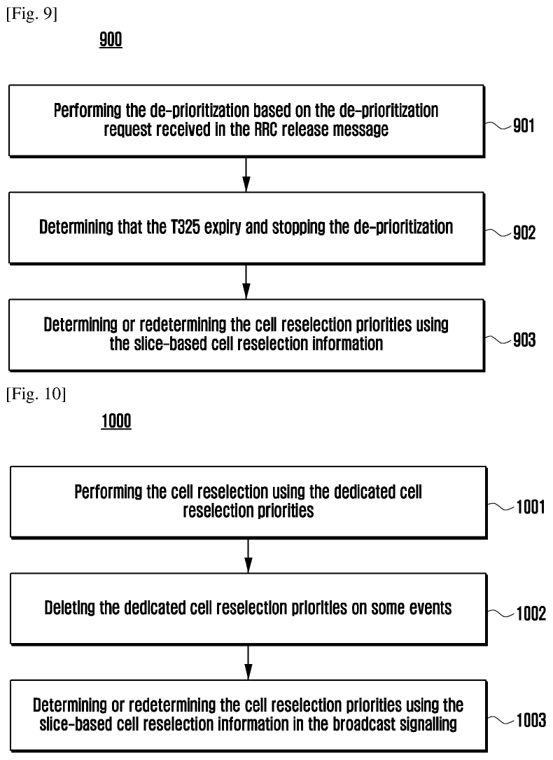

FIG. 9 illustrates an operational flow diagram illustrating a method (900) for stopping a de-prioritization along with slice-based reselection, according to an embodiment as disclosed herein.

At step 901, the method (900) includes performing the de-prioritization based on the de-prioritization request received in the RRC release message, which relates to step 301 of FIG. 3.

At step 902, the method (900) includes determining the T325 expiry and stopping the de-prioritization, which relates to step 304 of FIG. 3.

At step 903, the method (900) includes determining or redetermining the cell reselection priorities using the slice-based cell reselection information, which relates to step 304 of FIG. 3.

FIG. 10 illustrates an operational flow diagram illustrating a method (1000) for a dedicated slice-based priority deletion along with slice-based reselection, according to an embodiment as disclosed herein.

At step 1001, the method (1000) includes performing the cell reselection using the dedicated cell reselection priorities, which relates to step 301 of FIG. 3.

At step 1002, the method (1000) includes deleting the dedicated cell reselection priorities on some events, which relates to step 304 of FIG. 3. For example, cell reselection priorities that are provided by the dedicated signaling may be deleted under certain circumstances. This may occur, for example, when the validity timer (T320 in NR) expires, when there is a change in the RRC state, or when an RRC release is received with the field cellreselectionPriorities present. Additionally, a PLMN selection or SNPN selection requested by NAS can also trigger the deletion of these priorities.

At step 1003, the method (1000) includes determining or redetermining the cell reselection priorities using the slice-based cell reselection information in the broadcast signalling, which relates to step 304 of FIG. 3.

In one or more embodiments, the disclosed method provides several advantages, which are listed herein. The disclosed method provides a process of selecting cell reselection priorities that involves considering various factors such as frequency pairs (e.g., NSAG frequency pairs) and configurations. In the case of slice-based cell reselection, it is necessary to identify the relevant NSAG frequency pairs that are present in both dedicated and broadcast signalling. However, it is important to note that the NSAG frequency pairs associated with the dedicated signalling may not always be available in the broadcast signalling. In such cases, the disclosed method performs one of (a) excludes the frequency pairs and utilizes only those that are present in both signalling types, and (b) the one or more slice-based cell reselection priorities are based on careful consideration of all the cells in the frequency in the NSAG frequency pair of the one or more received configurations in the dedicated signalling supports the NSAG in the NSAG frequency pair. As a result, the disclosed method may ensure that the cell reselection priorities are based on accurate and reliable information, which may help to optimize network performance, network operators may provide seamless connectivity and high-quality services to the users and enhance the overall user experience.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a user equipment (UE) for determining one or more slice-based cell reselection priorities in a wireless network, the method comprising:
receiving a radio resource control (RRC) release message including a first configuration of slice-specific cell reselection information;
receiving, from a base station, system information including a second configuration of the slice-specific cell reselection information; and
considering a cell on a frequency to support all slices of a network slice access stratum (AS) group (NSAG), in case that the NSAG for the frequency is indicated by the first configuration included in the RRC release message and not indicated by the second configuration included in the system information.

17. The method of claim 16, wherein the NSAG for the frequency is included in NSAG information provided by a non-access stratum (NAS), and
wherein the RRC release message is signaled based on dedicated signaling and the system information is signaled based on broadcast signaling.

18. The method of claim 16, wherein a cell reselection priority is determined by considering the cell on the frequency to support all slices of the NSAG.

19. The method of claim 18, wherein, in case that an NSAG X is included in the RRC release message and not included in the system information, the cell reselection priority is determined considering the cell on the frequency to support all slices of the NSAG X.

20. The method of claim 18, wherein, in case that an NSAG Y for a frequency Y is included in the RRC release message and the NSAG Y for the frequency Y is not included in the system information, the cell reselection priority is determined considering the cell on the frequency Y to support all slices of the NSAG Y.

21. The method of claim 16, wherein the NSAG for the frequency is defined as an NSAG-frequency pair.

22. The method of claim 16, wherein the first configuration includes frequency priority dedicated slicing information,
wherein the frequency priority dedicated slicing information includes frequency information and a dedicated slice information list,
wherein the dedicated slice information list includes dedicated slice information, and
wherein the dedicated slice information includes at least one of NSAG identity information, an NSAG cell reselection priority, or an NSAG cell reselection sub priority.

23. The method of claim 16, wherein the second configuration includes frequency priority slicing information,
wherein the frequency priority slicing information includes frequency information and a slice information list,
wherein the slice information list includes slice information, and
wherein the slice information includes at least one of NSAG identity information, an NSAG cell reselection priority, or an NSAG cell reselection sub priority.

24. A user equipment (UE) in a wireless network, the UE comprising:
a transceiver; and
a processor configured to:
receive a radio resource control (RRC) release message including a first configuration of slice-specific cell reselection information,
receive, from a base station, system information including a second configuration of the slice-specific cell reselection information, and
consider a cell on a frequency to support all slices of a network slice access stratum (AS) group (NSAG), in case that the NSAG for the frequency is indicated by the first configuration included in the RRC release message and not indicated by the second configuration included in the system information.

25. The UE of claim 24, wherein the NSAG for the frequency is included in NSAG information provided by a non-access stratum (NAS), and
wherein the RRC release message is signaled based on dedicated signaling and the system information is signaled based on broadcast signaling.

26. The UE of claim 24, wherein a cell reselection priority is determined by considering the cell on the frequency to support all slices of the NSAG.

27. The UE of claim 26, wherein, in case that an NSAG X is included in the RRC release message and not included in the system information, the cell reselection priority is determined considering the cell on the frequency to support all slices of the NSAG X.

28. The UE of claim 26, wherein, in case that an NSAG Y for a frequency Y is included in the RRC release message and the NSAG Y for the frequency Y is not included in the system information, the cell reselection priority is determined considering the cell on the frequency Y to support all slices of the NSAG Y.

29. The UE of claim 24, wherein the NSAG for the frequency is defined as an NSAG-frequency pair.

30. The UE of claim 24, wherein the first configuration includes frequency priority dedicated slicing information,
wherein the frequency priority dedicated slicing information includes frequency information and a dedicated slice information list,
wherein the dedicated slice information list includes dedicated slice information, and
wherein the dedicated slice information includes at least one of NSAG identity information, an NSAG cell reselection priority, or an NSAG cell reselection sub priority.

31. The UE of claim 24, wherein the second configuration includes frequency priority slicing information,
wherein the frequency priority slicing information includes frequency information and a slice information list,
wherein the slice information list includes slice information, and
wherein the slice information includes at least one of NSAG identity information, an NSAG cell reselection priority, or an NSAG cell reselection sub priority.
